(19) United States
(12) Patent Application Publication
(10) Pub. No.: US 2013/0295332 A1
(43) Pub. Date: Nov. 7, 2013

(54) Imitation Leather, Method for Manufacturing Imitation Leather and Method for Manufacturing Imitation Leather Material

(71) Applicants: Chih-Hsien Huang, Taipei City (TW); Kuo-Hsiung Wang, Taipei City (TW)

(72) Inventors: Chih-Hsien Huang, Taipei City (TW); Kuo-Hsiung Wang, Taipei City (TW)

(21) Appl. No.: 13/465,079

(22) Filed: May 7, 2012

(51) Int. Cl. D06N 3/00; C08L 89/06; B29C 47/00; B32B 37/24; B32B 5/16; B32B 9/02

(52) U.S. Cl. 428/151; 428/323; 442/59; 428/220; 264/177.1; 156/244.11; 524/11

(57) ABSTRACT

An method for manufacturing an imitation leather includes preparing an animal skin powder, blending the animal skin powder and a matrix to form the imitation plastic material and then the imitation plastic material being cooled and granulated to form granules and melting and feeding the granules of the imitation plastic material to a sheet extruding equipment to extrude the flexible sheet imitation leather. The animal skin powder comprises an animal epidermis powder and has a particle size of 0.2 um-0.3 mm. The matrix comprises an elastic material. The animal skin powder and the matrix are blended under a blending temperature between 100-160° C. and the animal skin powder is present in the imitation plastic material in an amount of 30-70 wt %, based on the total weight of the imitation plastic material.

### BACKGROUND OF THE INVENTION

1. Field of Invention

The present invention relates to a leather, and more particularly to an imitation leather that comprises an animal skin powder.

2. Description of the Related Art

Leather is widely used on articles for daily use, such as tables, chairs, sofas, shoes, clothes, etc. and can add quality and aesthetic feelings or durability to these articles. Generally there are two kinds of leather, artificial or natural leathers. Natural leather is made from animal skins and animal skins need many manufacturing processes, such as hair removing, drying, washing, softening, dying, trimming and cutting, to form leather materials with a flat surface and good quality.

Although natural leather is useful and beautiful, a lot of detrimental additives must be used and added during its manufacturing processes. Moreover, animal skins used for making natural leather must be cut and trimmed according to their size and shape to improve the appearance of natural leather. Thus, a huge amount of waste animal skin and hair is produced. The waste is difficult to treat and may cause environmental pollution. Animal skins must also be processed one by one and thus natural leather can't be manufactured continuously.

To overcome the shortcomings, the present invention provides an imitation leather material to mitigate or obviate the aforementioned problems.

### SUMMARY OF THE INVENTION

The primary objective of the present invention is to provide a method for manufacturing an imitation leather material, a method for manufacturing an imitation leather, and an imitation leather that is high quality and similar to natural leather and can be manufactured continuously and decrease environmental pollution.

The method for manufacturing an imitation leather material of the present invention comprises preparing an animal skin powder and blending the animal skin powder and a matrix to form an imitation plastic material and then the imitation plastic material is cooled and granulated to form the granule imitation leather material. The animal skin powder comprises an animal epidermis powder and has a particle size of 0.2 um-3 mm. The matrix comprises an elastic material.

The method for manufacturing an imitation leather of the present invention comprises preparing an animal skin powder, blending the animal skin powder and a matrix to form an imitation plastic material and then the imitation plastic material is cooled and granulated to form a granule imitation leather material and melting and feeding the granule imitation leather material to a sheet extruding equipment to extrude the flexible sheet imitation leather. The animal skin powder comprises an animal epidermis powder and has a particle size of 0.2 um-0.3 mm. The matrix comprises an elastic material.

A surface of the imitation leather is glued and laminated with a functional layer and the functional layer is a sheet elastomer, an animal leather or a cloth.

The animal skin powder and the matrix are blended under a blending temperature between 100-160° C. and the animal skin powder is present in the imitation plastic material in an amount of 30-70 wt %, based on the total weight of the imitation plastic material.

The animal skin powder further comprises an animal hair powder. The elastic material is selected from the group consisting of polyurethane, styrenic elastomers, polyolefin elastomer, ethylene-propylene rubber, and mixtures thereof. The matrix further comprises an additive and the additive comprises a dye or an anti-blocking agent.

The animal skin powder and the matrix are blended by using a single screw or twin screw extruder. The animal skin powder is present in the imitation plastic material in an amount of 30-40 wt %, based on the total weight of the imitation plastic material. The animal skin powder has a particle size of 0.2 um-3 mm.

The animal skin powder has a particle size of 1-3 um.

The sheet imitation leather has a thickness of 0.2-1.5 mm.

An imitation leather of the present invention is sheet and comprises a matrix and an animal skin powder blended with the matrix. The animal skin powder comprises an animal epidermis powder and has a particle size of 0.2 um-3 mm. The matrix comprises an elastic material selected from the group consisting of polyurethane, styrenic elastomers, polyolefin elastomer, ethylene-propylene rubber, and mixtures thereof.

The imitation leather has a textured surface.

A surface of the imitation leather is glued and laminated with a functional layer and the functional layer is a sheet elastomer, an animal leather or a cloth.

The animal leather comprises an animal dermis layer or an animal adipose layer.

The imitation leather has a thickness of 0.2-1.5 mm.

The animal skin powder has a particle size of 0.2 um-3 mm and is present in the imitation leather in an amount of 30-70 wt %, based on the total weight of the imitation leather.

Other objectives, advantages and novel features of the invention will become more apparent from the following detailed description when taken in conjunction with the accompanying drawings.

### BRIEF DESCRIPTION OF THE DRAWINGS

No drawing is provided.

### DETAILED DESCRIPTION OF THE INVENTION

An embodiment of the method for manufacturing the imitation leather of the present invention includes steps of preparing, blending and granulating, extruding, texturing and gluing and laminating.

In the step of preparing, an animal skin powder is prepared and comprises an animal epidermis powder. The animal skin powder can further includes an animal hair powder. Before an animal skin, such as cattle or pig skins, is further processed and laminated with other leathers, the animal skin generally is treated to remove its hair and then a layer of epidermis of the animal skin is scraped or rubbed to be removed, so as to improve its quality feelings and facilitate its processing. Thus, a great amount of waste animal skin powder, including animal epidermis powder and animal hair powder, will be generated. In an embodiment of the present invention, the animal skin powder comes from recycling waste animal skin powder generated from pre-treatment of animal skins. The animal skin powder can have a particle size of 0.2 um-3 mm, preferably 0.2-3 um, and more preferably 1-3 um. In the step of blending and granulating, the animal skin powder is added to and blended with a matrix to form an imitation plastic material and then the imitation plastic material is cooled and granulated. The matrix comprises an elastic material and can further include additives. The matrix can be melt and blended with the animal skin powder or can be blended with the animal skin powder under a high blending temperature. The elastic material comprises one or more thermoplastic rubbers, such as polyurethane (TPU), styrenic elastomers such SBS (styrene-butadiene-styrene) elastomer and SEBS (styrene-ethylene-butadiene-styrene) elastomer, polyolefin elastomer such as POE (polyoxyethylene), ethylene-propylene rubber such as EPDM (ethylene propylene diene monomer), and mixtures thereof. The matrix can further include additives such as a dye (color masterbatch) or an anti-blocking agent. The dye gives color to the matrix and the imitation plastic material. The anti-blocking agent facilitates blending and subsequent processing. After the animal skin powder and the matrix are blended and uniformly mixed, the imitation plastic material is cooled and granulated to a granule imitation leather material.

Various blending processes can be used on the method of the present invention and thus different amounts of the animal skin powder can be added and blended with the matrix. The following examples are provided only for illustration.

### EXAMPLE 1

In a test run, the animal skin powder and the matrix are blended and uniformly mixed under a high blending temperature by using a single screw or twin screw extruder to form the imitation plastic material and the animal skin powder is present in the imitation plastic material in an amount of 30-40 wt %, based on the total weight of the imitation plastic material. When granulating, the imitation plastic material under a flow state is extruded from an output port of the extruder to form bars. The bars are then cooled and cut into granules. The animal skin powder and the matrix are blended under a blending temperature at which the matrix will soften. To prevent the animal skin powder from degrading or cracking due to high temperature, the blending temperature is preferably between 100-160° C. Preferably, the animal skin powder has a particle size between 0.2 um-3 mm such that the animal skin powder can be blended more easily and dispersed in the matrix more evenly.

### EXAMPLE 2

In a test run, the animal skin powder and the matrix are blended and uniformly mixed under a blending temperature by using a continuous blender to form the imitation plastic material and the animal skin powder is present in the imitation plastic material in an amount of 30-70 wt %, based on the total weight of the imitation plastic material. The animal skin powder has a particle size of 0.2-3 um. The blending temperature is preferably between 100-160° C.

When granulating, an output port of the continuous blender can be connected to a single screw extruder and the imitation plastic material is extruded from the output port of the single screw extruder to form bars. The bars are then cooled and cut into granules.

### EXAMPLE 3

In a test run, the animal skin powder and the matrix are blended and uniformly mixed under a blending temperature by using a batch blender, such as a bundery or needer, to form the imitation plastic material and the animal skin powder is present in the imitation plastic material in an amount of 70 wt %, based on the total weight of the imitation plastic material. The animal skin powder has a particle size of 0.2 um-3 mm. The blending temperature is preferably between 100-160° C. The granulating of the imitation plastic material can be similar to Example 2.

In the step of extruding, the granule imitation leather material is extruded to form an imitation leather. For example, the granule imitation leather material is melted and fed to a sheet extruding equipment, such as T-Die or sheet extruding machine, to extrude as a flexible sheet imitation leather. The sheet imitation leather can have a thickness of 0.2-1.5 mm, preferably 0.3-0.35 mm, to achieve better processing property, flexibility and tactile feeling. Because the imitation leather of the present invention can be formed continuously by using an extruding equipment, the &limed imitation leather can be cut by using a cutting device or packed by using a rolling device. Thus, the imitation leather can be manufactured and then processed continuously.

In the step of texturing, the extruded imitation leather can be pressed and textured to form a textured surface. The textured surface can add particular visual or tactile feelings to the imitation leather. Thus, the textured imitation leather can have a high value or be applied on different fields.

In the step of gluing and laminating, a surface of the imitation leather, which may be textured or not textured, is glued and laminated with a functional layer. The functional layer can be a sheet elastomer, an animal leather or a cloth. The sheet elastomer can be made from the elastic material of the matrix. The animal leather can comprise an animal dermis layer or an animal adipose layer. The step of gluing and laminating can be repeated so more than one functional layer can be laminated to the imitation leather. Thus, the imitation leather can form a sandwich structure or multilayer structure. For example, a cloth and a TPU sheet elastomer can be laminated in turn to the imitation leather to form a sandwich structure. Alternatively, the imitation leather can form a multilayer structure with functional layers such as artificial leather/animal leather, artificial leather/cloth, or artificial leather/bonding layer/cloth. Thus, the mechanical strength or other properties of the imitation leather can be improved.

According to the foregoing description, the imitation leather of the present invention has the following advantages:

1. The imitation leather can be made from recycling waste of animal skin and is similar to animal leather at visual and tactile feelings. Therefore, the present invention can reuse the waste of animal skin and decrease the use of plastics so as to mitigate environmental pollution.

2. Conventional natural leather can only be made one by one. The present invention can use a continuous extruding process and achieve mass production of high quality imitation leather similar to natural leather.

3. The elastic material of the matrix used in the present invention is highly compatible with aqueous solvents generally used in conventional leather treatments. Thus, the imitation leather of the present invention is easy to undergo surface treatments.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the tern's in which the appended claims are expressed.

What is claimed is:

1. A method for manufacturing an imitation leather material comprising
preparing an animal skin powder, the animal skin powder comprising an animal epidermis powder and having a particle size of 0.2 um-3 mm; and
blending the animal skin powder and a matrix to form an imitation plastic material and then the imitation plastic material being cooled and granulated to form the granule imitation leather material, the matrix comprising an elastic material.

2. The method of claim 1, wherein
the animal skin powder further comprises an animal hair powder;
the elastic material is selected from the group consisting of polyurethane, styrenic elastomers, polyolefin elastomer, ethylene-propylene rubber, and mixtures thereof; and
the matrix further comprises an additive and the additive comprises a dye or an anti-blocking agent.

3. The method of claim 2, wherein
the animal skin powder and the matrix are blended under a blending temperature between 100-160° C.; and
the animal skin powder is present in the imitation plastic material in an amount of 30-70 wt %, based on the total weight of the imitation plastic material.

4. A method for manufacturing an imitation leather comprising
preparing an animal skin powder, the animal skin powder comprising an animal epidermis powder and having a particle size of 0.2 um-3 mm;
blending the animal skin powder and a matrix to form an imitation plastic material and then the imitation plastic material being cooled and granulated to form a granule imitation leather material, the matrix comprising an elastic material; and
melting and feeding the granule imitation leather material to a sheet extruding equipment to extrude the flexible sheet imitation leather.

5. The method of claim 4, wherein
a surface of the imitation leather is glued and laminated with a functional layer; and
the functional layer is a sheet elastomer, an animal leather or a cloth.

6. The method of claim 5, wherein
the animal skin powder and the matrix are blended under a blending temperature between 100-160° C.; and
the animal skin powder is present in the imitation plastic material in an amount of 30-70 wt %, based on the total weight of the imitation plastic material.

7. The method of claim 6, wherein
the animal skin powder further comprises an animal hair powder;
the elastic material is selected from the group consisting of polyurethane, styrenic elastomers, polyolefin elastomer, ethylene-propylene rubber, and mixtures thereof; and
the matrix further comprises an additive and the additive comprises a dye or an anti-blocking agent.

8. The method of claim 7, wherein
the animal skin powder and the matrix are blended by using a single screw or twin screw extruder;
the animal skin powder is present in the imitation plastic material in an amount of 30-40 wt %, based on the total weight of the imitation plastic material; and
the animal skin powder has a particle size of 0.2-3 um

9. The method of claim 7, wherein
the animal skin powder has a particle size of 1-3 um.

10. The method of claim 7, wherein
the sheet imitation leather has a thickness of 0.2-1.5 mm.

11. An imitation leather being sheet and comprising a matrix and an animal skin powder being blended with the matrix, wherein
the animal skin powder comprises an animal epidermis powder and has a particle size of 0.2 um-3 mm; and
the matrix comprises an elastic material selected from the group consisting of polyurethane, styrenic elastomers, polyolefin elastomer, ethylene-propylene rubber, and mixtures thereof.

12. The imitation leather of claim 11 having a textured surface.

13. The imitation leather of claim 11, wherein
a surface of the imitation leather is glued and laminated with a functional layer; and
the functional layer is a sheet elastomer, an animal leather or a cloth.

14. The imitation leather of claim 13, wherein
the animal leather comprises an animal dermis layer or an animal adipose layer.

15. The imitation leather of claim 14 having a thickness of 0.2-1.5 mm.

16. The imitation leather of claim 15, wherein
the animal skin powder has a particle size of 0.2-3 um and is present in the imitation leather in an amount of 30-70 wt %, based on the total weight of the imitation leather.
